(19) United States
(12) Patent Application Publication
(10) Pub. No.: US 2007/0023581 A1
(43) Pub. Date: Feb. 1, 2007

(54) Omnidirectional aircraft

(76) Inventor: William H.T. La, Stockton, CA (US)

Correspondence Address: WILLIAM H.T. LA, # 313, 6507 Pacific Ave., Stockton, CA, 95207, US

(21) Appl. No.: 11/182,877

(22) Filed: Jul. 16, 2005

Related U.S. Application Data
(60) Provisional application No. 60/588,868, filed on Jul. 16, 2004.

(51) Int. Cl. B64G 1/28

(52) U.S. Cl. 244/165

(57) ABSTRACT

An omni-directional aircraft with flight capabilities surpassing those of a regular VTOL or helicopter, being able to take full advantage of the simultaneous six degrees of freedom of motion possible in the atmosphere, undergoing any desired combination of translational and rotational movement, and keeping station in the air in any arbitrary attitude. In the preferred embodiment, the flying object comprises a cubic body on the six faces of which are mounted six propulsion units, such that the propellers on each pair of opposite faces are coplanar with each other and with the main axis passing through the centers of these opposite faces, and their thrusts act along the direction of another main axis, each of the three pairs of propellers acting along a different one of the cube's three main axes. The thrust from each motion-inducing assembly being continuously variable and reversible, the resultant translational and rotational thrust vectors can be positioned arbitrarily within their respective solid envelopes. A control element with equal freedom of motion allows intuitive piloting of the vehicle. In an alternate embodiment, the propulsion units are disposed along the sides of a tetrahedron.

### CROSS REFERENCE TO RELATED APPLICATIONS

This application claims the benefit of provisional application Ser. No. 60/588,868 filed on Jul. 16, 2004.

### FEDERALLY SPONSORED RESEARCH

Not Applicable

### SEQUENCE LISTING OR PROGRAM

Not Applicable

### BACKGROUND OF THE INVENTION

1. Field of Invention

This invention relates to aircraft, and more specifically to aircraft that can move in any direction without reorienting themselves.

2. Description of Prior Art

For the purpose of this disclosure, we shall define an omni-directional aircraft as a self-propelled atmospheric flying object having the ability to instantaneously and simultaneously undergo a combination of translational acceleration in any arbitrary direction and rotational acceleration about any arbitrary axis relative to a three-dimensional frame of reference attached to its body. Such a flyer can then take full advantage of the six degrees of freedom of motion available to an object in three-dimensional space, commonly referred to as fore-aft, left-right, up-down, roll, pitch and yaw.

The ability to move in any chosen direction, rotate about any chosen axis, and remain stationary in any chosen attitude, is desirable in an aircraft in applications where maneuverability is of paramount importance. This would be useful, for example, in flying in a spherical orbit around another airborne object while facing it. No known current aircraft design affords full omnidirectionality.

In terms of limited omnidirectionality, lighter than air craft with improved maneuverability have been proposed, such as the airship disclosed in U.S. Pat. No. 5,383,627 to Bundo (1995), powered by two propellers supported on gimbals. While it can move in any direction as claimed, this device cannot do so in combination with an arbitrary rotation. In addition, airships are inherently bulky and slow, and their usefulness in general aviation is limited.

Tail-sitting VTOL aircraft cannot fly backward. Tiltrotor VTOL's cannot change direction of thrust instantaneously. U.S. Pat. No. 5,823,468 to Bothe (1998), U.S. Pat. No. 6,254,032 to Bucher (2001), and U.S. Pat. No. 6,286,783 to Kuenkler (2001) disclose aircraft powered by four or more pivoting propeller assemblies. These suffer from the same limitations.

Rotary wing aircraft are generally better adapted for motion in any direction, but still cannot hover in a nose-up or nose-down attitude. In order to achieve horizontal omnidirectionality, helicopters make use of complex and costly mechanisms to effect cyclic pitch variation of their rotor blades.

In terms of differential steering, U.S. Pat. No. 5,087,000 to Suto (1992) discloses a model aircraft of conventional design in which flight speed/climb and steering control are accomplished by changing the collective and differential thrust delivered by tandem propellers, thus negating the need for mechanical control surfaces. The differential steering principle is analogous to that used in tracked land vehicles.

In terms of orthogonally disposed propellers, U.S. Pat. No. 5,890,441 to Swinson et al. (1999) discloses a horizontal or vertical take off aircraft incorporating a pair of longitudinally-directed propellers providing forward thrust and a pair of vertically-directed propellers supplying upward thrust.

Objects and Advantages

An object of the present invention is to provide an aircraft that is fully omnidirectional. A resulting advantage of this feature is the ability to engage in intricate maneuvers not afforded by other aircraft. Another advantage is the ability to navigate in confined and contorted spaces while assuming any arbitrary orientation. Another advantage is the ability to continue flying controllably, if not omnidirectionally, in the event of loss of a propulsion unit. Further objects and advantages of the present invention will become apparent from a consideration of the ensuing description and drawings.

### BRIEF SUMMARY OF THE INVENTION

In accordance with the present invention, an exemplary preferred embodiment omnidirectional aircraft comprises a body on which are mounted three pairs of shrouded propellers along the three main axes: longitudinal (Y-axis), transverse (X-axis), and vertical (Z-axis). Each propeller can provide a continuous range of thrust from full negative to full positive. This feature can be accomplished in different ways. In one embodiment of the propulsion units, the propellers rotate at a substantially constant speed, and their blade pitch can be continuously adjusted from a negative to a positive angle. In this case, the propellers can all be driven from one power plant, and each pair counterrotates for torque cancellation. In another embodiment of the propulsion units, the propellers have fixed bidirectional blade geometry, but their speed and direction of rotation can be varied. In this case, each propeller is driven by its own motor.

The six propellers, acting together, can impart on the vehicle an arbitrary linear thrust vector simultaneous with an arbitrary rotary thrust vector. Within the limits of the thrust range, the aircraft is agile enough to mimick the motion of an object held in one's hand, moved and tumbled through space in a random fashion.

To control such an aircraft, there are again a number of possible methods. In one embodiment of the control system, a control element in the form of a steering wheel or globe is articulated to be moveable by the operator up-down, left-right and forward-back, and twistable around all three of these axes. Sensors translate these six motions to corresponding command inputs for the vehicle. In a robot-like mode, the inputs are interpreted by the electronic control system as position commands, in which case the flying object mimicks the positioning of the control element in space, moving when the globe is moved, stopping when it is not. In a vehicle-like mode, the inputs are interpreted as more familiar velocity commands.

In another embodiment of the control system, such as for model radio control applications, two 3-axis joysticks are manipulated by the operator's two hands, inputs from the left joystick being interpreted as angular velocity commands, and inputs from the right joystick being interpreted as linear velocity commands.

In an alternate embodiment of the present invention, the six propellers are disposed along the sides of a tetrahedron, such that the plane of each propeller includes the center of the tetrahedron. The translation from input to output commands is straightforward. This arrangement lends itself to a sturdier, lighter structure.

### BRIEF DESCRIPTION OF THE DRAWINGS

Drawing Figures

FIG. 1 is a rear perspective view of the preferred embodiment aircraft.

FIG. 2 is the same rear perspective view showing the reference axes of translation and rotation.

FIG. 3 is a rear perspective view of an alternate embodiment, with an angled arrangement of the propulsion units.

FIG. 4 is the same rear perspective view showing the tetrahedron defined by the propulsion units.

### REFERENCE NUMERALS IN DRAWINGS

10 Aircraft
12 Body
14 Left propulsion unit
16 Right propulsion unit
18 Rear propulsion unit
20 Front propulsion unit
22 Bottom propulsion unit
24 Top propulsion unit
26 Right propulsion unit mount
28 Rear propulsion unit mount
30 Top propulsion unit mount

### DETAILED DESCRIPTION

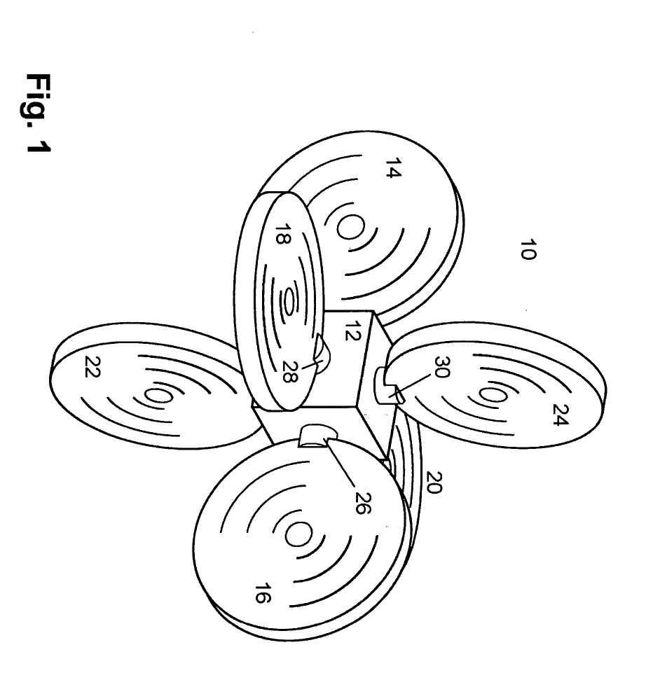

FIG. 1 shows in rear perspective view the preferred embodiment of the omnidirectional aircraft 10 comprising a cubic body 12 on which are mounted six propulsion units 14, 16, 18, 20, 22 and 24 through six mounts, of which three are visible: 26, 28 and 30. Each propulsion unit includes a peripheral hood, a motor centrally supported on struts attached to the hood, and a propeller attached to the motor.

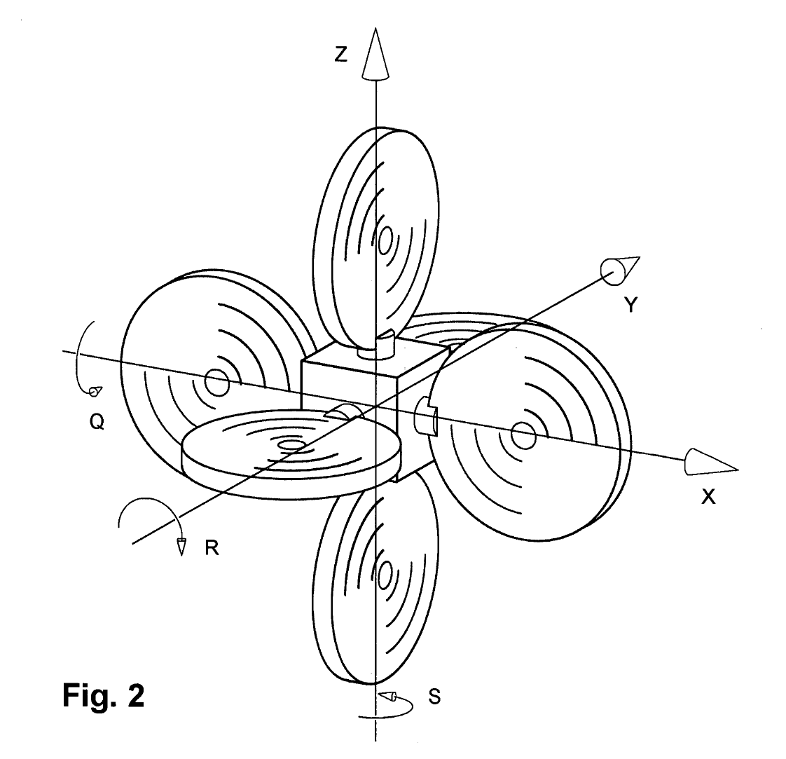

FIG. 2 is the same view of the aircraft showing the six coordinate references. The three translational degrees of freedom are represented by the set of three orthogonal axes, transverse axis X, longitudinal axis Y, and vertical axis Z. The three rotational degrees of freedom are represented by pitch Q around axis X, roll R around axis Y, and yaw S around axis Z.

The six propulsion units are organized in three pairs lying along the three axes. The first pair, comprising coplanar units 14 and 16, is disposed along transverse axis X, and collectively provides positive or negative translational thrust in longitudinal direction Y, and also differentially provides positive or negative rotational thrust in yaw direction S. The second pair, comprising coplanar units 18 and 20, is disposed along longitudinal axis Y, and collectively provides positive or negative translational thrust in vertical direction Z, and also differentially provides positive or negative rotational thrust in pitch direction Q. The third pair, comprising coplanar units 22 and 24, is disposed along vertical axis Z, and collectively provides positive or negative translational thrust in transverse direction X, and also differentially provides positive or negative rotational thrust in roll direction R. Thus in this arrangement, the plane of the propellers in each pair is parallel to two opposite faces of the reference cube 12. We will refer to this as the cubic embodiment of the present invention.

Within the envelope of maximum attainable thrust, any arbitrary combination of translational thrust vector and rotational thrust vector can be achieved by this arrangement. Let the thrust values delivered by propelling means 14, 16, 18, 20, 22 and 24 be represented respectively by a, b, c, d, e and f, let the desired translational thrust vector be represented by coordinates x, y and z relative to axes X, Y and Z, and let the desired rotational thrust vector be represented by coordinates q, r and s relative to axes Q, R and S. In the simplest terms, neglecting scale factors and other effects such as propeller torque reaction, gyroscopic precession, etc., the motor commands can be expressed in terms of the desired vehicle motion as follows:
a=(y−s)/2
b=(y+s)/2
c=(z−q)/2
d=(z+q)/2
e=(x−r)/2
f=(x+r)/2

The desired motion commands x, y, z, q, r and s can be input by the aircraft's pilot, or a remote operator, by any of a number of possible means. In the case of a radio control model aircraft, the operator can use two 3-axis joysticks mounted in the radio transmitter box. The six degrees of motion control can be assigned to the joystick axes according to individual preference. For example, the left joystick can input the translational vector, while the right joystick handles all three rotational values. The simple signal mixing shown above can be handled by a programmable R/C transmitter. If stabilizing gyroscopes are used, signal mixing is done onboard the model airplane.

In the case of a full-scale aircraft carrying a pilot, a control handle can be mechanically mounted on an XYZ slide table with gimbals providing QRS articulation, all axes being fitted with finger-activated trim controls, zeroing springs and, as needed, with acceleration-neutralizing counterweights. Locking mechanisms on selected axes are used to fix steady state input values, such as for maintaining forward cruising speed without constant operator pressure on the control handle. Flying the aircraft is then intuitive, with the vehicle moving in the direction in which the handle is displaced, and steering in the direction in which the handle is twisted.

Each propulsion device must be capable of delivering a precise, continuous range of thrust from full positive to full negative. One way to fulfill this requirement is by having a reversible, variable-speed motor turning a fixed-pitch, symmetrical-blade propeller. This is readily accomplished in a model aircraft by using a bidirectional speed controller and a reversible electric motor turning a flat-blade ducted fan. Another way to fulfill the requirement is by using a collectively variable pitch rotor turning at a substantially constant rate. In this case, two or more of the propulsion units can share the mechanical output from one motor or engine located within the body through a transmission system such as used to drive a conventional helicopter's tail rotor. The pitch control mechanism would also be similar to a tail rotor's, as is well known to the art. It is desirable for the members of each pair of rotors to operate in counterrotation for torque and gyroscopic moment cancelling.

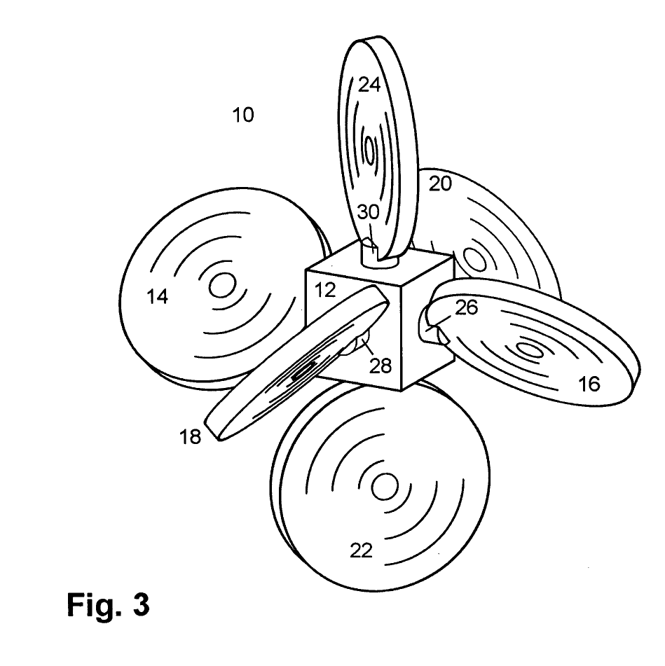

FIG. 3 shows an alternate embodiment of the present invention, in which each of the six propulsion units is rotated from its configuration of the previous embodiment. For each of the three pairs, the member that lies on the negative side of the supporting axis is rotated by 45 degrees in the negative direction, and the member that lies on the positive side of the supporting axis is rotated by 45 degrees on the positive direction. Thus, unit 14 is rotated −45 degrees along Q, and unit 16 is rotated +45 degrees in Q. Similarly, unit 18 undergoes −45 degrees and unit 20 is turned +45 degrees in R, while unit 22 is pivoted −45 degrees and unit 24 is twisted +45 degrees in S. The two members of each pair are now orthogonal to each other, and no two of the six units are coplanar.

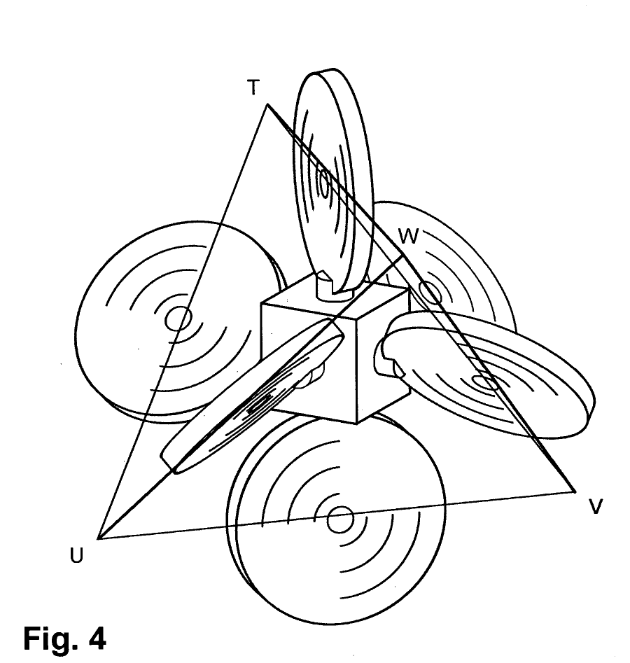

FIG. 4 illustrates that the six propulsion assemblies now lie along the sides of an equilateral tetrahedron with vertices T, U, V and W. Unit 14 lies on side TU while its X-axis homolog 16 lies on VW. Similarly, unit 18 is located on UW while its Y-axis homolog 20 sits on TV, and Z-axis homologs 22 and 24 occupy UV and TW respectively. It should be noted that the lines defined by the rotational axes of propellers 14, 16, 18, 20, 22 and 24 form another tetrahedron, not shown, which is the dual, or reciprocal, of tetrahedron TUVW, the two intertwined figures together forming a stella octangula. We will refer to this arrangement as the tetrahedral embodiment of the present invention. The control transfer equation becomes:
a=(y−z−r−s)/2√2
b=(y+z−r+s)/2√2
c=(−x+z−q−s)/2√2
d=(x+z+q−s)/2√2
e=(x−y−q−r)/2√2
f=(x+y−q+r)/2√2

The disadvantage in this configuration compared to the cubic arrangement is in the lower translational motion efficiency, since at most only one unit is pointed straight in the direction of travel. On the other hand, the thrust vectors from the individual propellers are now evenly distributed in space, resulting in overall translational and rotational spatial thrust envelopes that are more nearly spherical, and motion omnidirectionality that is more homogeneous. If the vehicle is resting on the perimeter of three of the propulsion units on a horizontal surface, this arrangement also provides a wider, more stable base than the previous one. In addition, the tetrahedral geometry enables a lighter construction method for the airframe, the body consisting of structural elements running along the six sides rather than a central hub.

An optional feature of the aircraft of the present invention is to have mounts 26, 28, 30, and the other three not shown, pivotally attached to body 12 and controlled so that the configuration of the propulsion units can be changed on the fly between the cubic and tetrahedral arrangements.

Applications

On a large scale, this omnidirectional flying device can be used as a very agile VTOL vehicle carrying pilots, passengers and other payload. This flyer has no inherent stability, and for most applications would need an onboard inertial navigation system together with an attitude and heading reference system. As an unmanned aircraft and in robotic applications, it would offer the advantage of total maneuverability. On a small scale, in a hobby and sport flying setting, it can take the form of a radio controlled geodesic sphere whose propulsion means are mostly hidden from sight. This beach ball-like flying object could perform magical stunts, such as rolling around on the ground, then seemingly rolling up an invisible ramp onto the roof of a building. It can be embedded in the skeletal framework of a conventional model airplane, and make that apparent plane perform impossible maneuvers, such as hovering in a nose down vertical attitude, or somersaulting on its wingtips.

Conclusion, Ramifications and Scope

Thus, the reader will see that the present invention provides a versatile aircraft that achieves full motion freedom in the atmosphere. While the above description contains many specificities, these should not be construed as limitations on the scope of the invention, but rather as an exemplification of preferred embodiments thereof. Many other variations are possible. As an example, the propulsion units do not all need to be identical. For a vehicle optimized for flight in the forward direction, the corresponding propellers can be larger than the others and have more powerful motors. The locations and angles of the propulsion units can also be changed to adapt the geometry to mission specific requirements. Accordingly, the scope of the invention should be determined not by the embodiments illustrated, but by the appended claims and their legal equivalents.

What is claimed is:

1. An omnidirectional aircraft comprising:
a body, six propulsion means, and a control means;
the body defining a reference system comprising an origin where intersect three mutually orthogonal reference axes, a first axis, a second axis, and a third axis, each axis having an origin, a negative direction and a positive direction, the origin and negative direction of said first, second and third axes respectively defining corresponding first, second and third negative half-axes, and the origin and positive direction of said first, second and third axes respectively defining corresponding first, second and third positive half-axes;
each of said six propulsion means being attached to said body through a mounting means, and defining a plane and a center in said plane through which passes a thrust axis having a negative direction and a positive direction, said thrust axis being normal to said plane; and each propulsion means being able to develop a motion-inducing force in the direction of its corresponding thrust axis, said force being continuously variable from a predetermined maximum negative value to a predetermined maximum positive value;
a first propulsion means having a center substantially located on said first negative half-axis, a second propulsion means having a center substantially located on said first positive half-axis, a third propulsion means having a center substantially located on said second negative half-axis, a fourth propulsion means having a center substantially located on said second positive half-axis, a fifth propulsion means having a center substantially located on said third negative half-axis, and a sixth propulsion means having a center substantially located on said third positive half-axis;
the six propulsion means being configured such that, from their collective action, the resultant translational thrust vector and the resultant rotational thrust vector each spans all directions of said reference system;
the control means being adapted to accept control input signals in the form of vehicle translation and rotation vectors, and to convert said signals to thrust commands for said propulsion means.

2. The device of claim 1 arranged in a cubic configuration, wherein said first and second propulsion means are substantially coplanar, their respective centers are substantially equidistant to said origin, and their respective thrust axes are substantially parallel to said second axis; said third and fourth propulsion means are substantially coplanar, their respective centers are substantially equidistant to said origin, and their respective thrust axes are substantially parallel to said third axis; and said fifth and sixth propulsion means are substantially coplanar, their respective centers are substantially equidistant to said origin, and their respective thrust axes are substantially parallel to said first axis.

3. The device of claim 1 arranged in a tetrahedral configuration, wherein said six propulsion means are substantially centrally disposed along the sides of an equilateral tetrahedron whose geometric center coincides with said origin, such that each propulsion means is substantially coplanar with its corresponding tetrahedral side and with said origin.

4. The device of claim 1 wherein said six mounting means are pivotable, such that said device can be reconfigured at will between a cubic configuration and a tetrahedral configuration.

5. The device of claim 1 wherein each said propulsion means comprises a shroud, a reversible electric motor centrally mounted within said shroud, and a propeller mounted on said motor.

6. The device of claim 1 wherein each said propulsion means comprises a shroud, a collectively variable pitch rotor rotatably mounted within said shroud, means for varying said pitch, and transmission means for driving said rotor at a substantially constant speed from a mechanical source located inside said body.

7. The device of claim 1 wherein said control means comprises a control input means, a navigation sensor means, a signal processing means, and a control output means.

8. The device of claim 7 wherein said control input means comprises a compound three-axis linear slide table, which accepts a three-axis angular gimbal system, which accepts a manual control element; sensor means to convert displacements and deflections of said manual control element into electrical input signals; trimming means to adjust the neutral levels of said input signals; mechanical zeroing means to return said manual control element to a neutral position in the absence of operator input; locking means for selectively engaging said control input means to maintain a steady state level of one or more input parameters; and mechanical counterbalancing means to prevent spurrious control input during vehicle translational and rotational acceleration and deceleration.
